(19) United States
(12) Patent Application Publication
(10) Pub. No.: US 2026/0103920 A1
(43) Pub. Date: Apr. 16, 2026

(54) MOTOR VEHICLE LOCK ARRANGEMENT FOR A CLOSURE ELEMENT OF A MOTOR VEHICLE

(71) Applicant: Brose Schließsysteme GmbH & Co. Kommanditgesellschaft, Wuppertal (DE)

(72) Inventors: Frank HÖRSCHGEN, Solingen (DE); Tatjana SCHMIDT, Leverkusen (DE)

(21) Appl. No.: 19/354,421

(22) Filed: Oct. 9, 2025

(30) Foreign Application Priority Data
Oct. 10, 2024 (DE) 102024129328.4

(51) Int. Cl. E05B 79/20; E05B 81/14

(52) U.S. Cl. CPC E05B 79/20; E05B 81/14

(57) ABSTRACT

A motor vehicle lock arrangement for a closure element of a motor vehicle, where the motor vehicle lock arrangement has a motor vehicle lock with a locking mechanism and a drive arrangement with a motor, which drive arrangement has a first flexible pulling means, wherein the motor can act on the first flexible pulling means in order to trigger a first function of the motor vehicle lock arrangement of a first maximum pulling force of the first flexible pulling means.

### CROSS-REFERENCE TO RELATED APPLICATION

This application claims priority pursuant to 35 U.S.C. 119(a) to German Application No. 102024129328.4, filed October 10, 2024, which application is incorporated herein by reference in its entirety.

### FIELD OF THE INVENTION

The present invention relates to a motor vehicle lock arrangement for a closure element of a motor vehicle according to the preamble of Claim 1, to a functional arrangement for a motor vehicle according to Claim 16, and to a motor vehicle with a motor vehicle lock arrangement or with a functional arrangement according to Claim 17.

### BACKGROUND

The term “closure element” is to be understood broadly in this case. It includes, for example, a tailgate, a trunk lid, a hood, a side door, a cargo area flap, a windowpane, a lifting roof or the like of a motor vehicle. The following focuses on the area of application of a side door of a motor vehicle. A closure element can be assigned to a motor vehicle lock arrangement having a motor vehicle lock which serves to hold the closure element in a closed position and to secure it against opening. Motor vehicle locks are to provide more convenient functions, in particular pushing open and/or pulling closed, at the lowest possible cost and with the smallest possible installation space. A motor vehicle lock usually has a locking mechanism with a lock latch and at least one pawl.

When pushed open, the closure element is moved into a gap position. The gap position is a position that lies beyond an open position of the motor vehicle lock. The open position, in turn, is the position that is reached when the motor vehicle lock is opened, i.e., specifically when the pawl is lifted. Due to the door sealing pressure and any spring preload of the lock latch that may exist, the closure element is pushed open slightly by lifting the pawl and the motor vehicle lock reaches the open position. However, with modern handleless side doors, a user should be able to open the side door by reaching into the gap between the motor vehicle body and the side door. The gap in the open position is not sufficient for comfortably reaching therein. A push-open arrangement is therefore provided, which pushes the side door, or more generally the closure element, open even further. For pushing the closure element into the gap position, the push-open arrangement has a push-open element and a motor with a motor shaft for moving the push-open element.

When being pulled closed, the lock latch is pulled closed by a motor, generally from a pre-closing position to a main closing position, i.e., moved in its closing direction. This means that the user does not have to close the closure element completely but can move it into the pre-closing position with little effort. Pulling it closed can also be advantageous in combination with a motor-driven closure element since the drive of the closure element then does not have to apply the force required to bring the closure element into the main closing position against the door sealing pressure. Drives for closure elements are generally not designed for such a combination of short travel and high torque.

The known prior art (EP 1536090 A2), on which the invention is based, relates to a motor vehicle lock arrangement according to the preamble of claim 1. This motor vehicle lock arrangement comprises a motor vehicle lock having a locking mechanism with a lock latch and a pawl. Furthermore, the motor vehicle lock arrangement has a drive arrangement with a motor, wherein the drive arrangement has a first flexible pulling means. The motor can act on the first flexible pulling means to trigger a first function of the motor vehicle lock arrangement. The motor vehicle lock arrangement is configured to trigger the first function with the first maximum pulling force of the first flexible pulling means. In case of doubt, this is the maximum motor force unless it is limited in some way. Drives with flexible pulling means have proven to be effective for implementing individual functions in motor vehicle locks. The more functions motor vehicle locks have, the higher the costs of these motor vehicle locks become and the more space the motor vehicle lock arrangements require.

It is a challenge to cost-effectively implement multiple functions of a motor vehicle lock while taking installation space requirements into account.

The invention is based on the problem of designing and developing the known motor vehicle lock arrangement in such a way that further optimization is achieved regarding the above challenge.

### SUMMARY

The above problem is achieved by the features of the characterizing part of Claim 1. The invention relates to a motor vehicle lock arrangement for a closure element of a motor vehicle, where the motor vehicle lock arrangement has a motor vehicle lock with a locking mechanism and a drive arrangement with a motor, which drive arrangement has a first flexible pulling means, wherein the motor can act on the first flexible pulling means in order to trigger a first function of the motor vehicle lock arrangement of a first maximum pulling force of the first flexible pulling means. It is proposed that the drive arrangement has a second flexible pulling means, that the motor can act on the second flexible pulling means in order to trigger a second function of the motor vehicle lock arrangement, that the motor vehicle lock arrangement is configured to trigger the second function with a second maximum pulling force of the second flexible pulling means, that the second maximum pulling force is smaller than the first maximum pulling force, that the second flexible pulling means is deflected at least once, and that the second flexible pulling means is deflected more frequently and/or by a larger angular range than the first flexible pulling means, and/or that, for a given equal pulling force, friction losses of the second flexible pulling means are higher than friction losses of the first flexible pulling means.

What matters is the essential consideration that a second flexible pulling means can be provided, which is driven by the same motor and via which a second function is implemented. However, it is then generally to be expected that one of the two functions, here the second function, requires less force than the other function. This can be considered by downregulating the motor power, for example via PWM. This results in a different maximum pulling force for the two functions that can act on the flexible pulling means. For example, 1000 N may be provided for the pushing open movement in the event of a crash, while a maximum of 400 N is provided for the pulling closed movement, in the sense of pinch protection as well.

Flexible pulling means have the advantage that they can be flexibly adapted to the available installation space by means of deflections and guides, which results in a high degree of flexibility. However, such deflections and guides lead to friction losses. The proposed finding is that dividing the flexible pulling means such that the flexible pulling means that must transmit less force has the higher friction losses or is at least deflected more frequently. A further advantage of less deflections of the more heavily loaded flexible pulling means is that deflection elements must be designed for the maximum force so that deflection elements for the second flexible pulling means can be designed to be more cost-effective. Even if friction was negligible, the proposed teaching is therefore advantageous.

In detail, it is proposed that the drive arrangement has a second flexible pulling means, that the motor can act on the second flexible pulling means in order to trigger a second function of the motor vehicle lock arrangement, that the motor vehicle lock arrangement is configured to trigger the second function with a second maximum pulling force of the second flexible pulling means, that the second maximum pulling force is smaller than the first maximum pulling force, that the second flexible pulling means is deflected at least once, and that the second flexible pulling means is deflected more frequently and/or by a larger angular range than the first flexible pulling means, and/or that, for a given equal pulling force, friction losses of the second flexible pulling means are higher than friction losses of the first flexible pulling means.

It should be noted that the maximum pulling force during normal operation of the motor vehicle, including in the event of a crash, is taken into consideration. Whether the motor can theoretically be made to also apply its maximum force to the second flexible pulling means through a test function or the like is not relevant.

Claim 2 relates to preferred embodiments of the deflections of the flexible pulling means and their differences.

According to Claim 3, deflection elements at which the flexible pulling means are deflected are preferably provided.

Claim 4 relates to preferred embodiments of the different pulling forces.

Claims 5 and 6 relate to preferred functions for which the maximum forces may be different and to which the proposed teaching can therefore be effectively applied.

Similarly to the deflection, torsion may also be provided, which can accordingly occur more frequently for the second flexible pulling means (claim 7).

Claim 8 relates to preferred differences in friction losses.

According to Claim 9, the first and second functions can be assigned to different motor directions, because of which they can be separated in a simple manner.

In an embodiment according to Claim 10, the pushing-open movement is assigned to the first flexible pulling means. In an embodiment according to Claim 11, lifting the pawl is assigned to the first flexible pulling means. Preferably, the pushing-open and lifting movements are accordingly performed in a synchronized manner via a common flexible pulling means. In an embodiment according to Claim 12, the pulling-closed movement is assigned to the second flexible pulling means. The pulling-closed movement is temporally/functionally independent of the pushing-open and lifting movements and is therefore preferably assigned to the other motor direction.

The flexible pulling means, in particular both can be wound onto and unwound from a winding shaft, particularly the same winding shaft, which can be coaxial with the motor shaft. This further results in a compact arrangement (Claim 13).

Claim 14 relates to preferred embodiments of the flexible pulling means, which may each be a strap. A sheathless embodiment, in particular in contrast to a Bowden cable, also increases flexibility and deflectability. In addition, a sheath already provides partial protection against friction losses, particularly those caused by deflection, so that the proposed advantages are particularly evident in the case of a sheathless flexible pulling means. A strap can be more stable than a rope and at the same time cost less. For this purpose, there is generally more surface area on the deflection element during deflection, which can increase friction.

Since the motor is preferably designed to push open the closure element and perform a second function even after a crash, it can preferably be regulated down (Claim 15).

According to a further teaching according to Claim 16, which has independent significance, a functional arrangement for a motor vehicle is claimed, wherein the functional arrangement has a drive arrangement with a motor, wherein the drive arrangement has a first flexible pulling means, wherein the motor can act on the first flexible pulling means in order to trigger a first function of the motor vehicle, in particular of the functional arrangement, wherein the functional arrangement is configured to trigger the first function with a first maximum pulling force of the first flexible pulling means. It is essential that the drive arrangement has a second flexible pulling means, that the motor can act on the second flexible pulling means in order to trigger a second function of the motor vehicle, in particular of the functional arrangement, that the functional arrangement is configured to trigger the second function with a second maximum pulling force of the second flexible pulling means, that the second flexible pulling means is deflected at least once, and that the second flexible pulling means is deflected more frequently and/or by a larger angular range than the first flexible pulling means, preferably that the second maximum pulling force is smaller than the first maximum pulling force. The functional arrangement may be the motor vehicle lock arrangement. In all the statements relating to the motor vehicle lock arrangement, the term “motor vehicle lock arrangement” may be replaced by “functional arrangement” and the motor vehicle lock or the unnecessary components of the motor vehicle lock may be optional. Preferably, the functional arrangement is a functional unit whose components form an assembly and which preferably interacts with a motor vehicle lock, in particular an external drive unit which has the, or some of, the components of the drive arrangement and possibly the control unit and/or the, or some of, the components of the push-open arrangement and thus forms an assembly. An external push-open unit can thus be provided as the functional arrangement, in which the first function is implemented in the push-open unit and which triggers the second function, for example via a Bowden cable connected to the second flexible pulling means, in the lock. The finding here is that the flexible pulling means being deflected a different number of times already results in increased flexibility in the arrangement of the flexible pulling means.

Reference may be made to all the statements relating to the proposed motor vehicle lock arrangement.

According to a further teaching according to Claim 17, which also has independent significance, a motor vehicle with motor vehicle lock arrangement as proposed or with functional arrangement as proposed is claimed.

Reference may be made to all the statements relating to the proposed motor vehicle lock arrangement and the proposed functional arrangement.

### BRIEF DESCRIPTION OF THE DRAWINGS

In the following, the invention is explained in more detail with reference to a drawing that merely represents exemplary embodiments. In the drawings

FIG. 1 a) shows a motor vehicle with a motor vehicle lock in b) an open position and c) a main closing position;

FIG. 2 shows the motor vehicle lock in a zero position;

FIG. 3 shows the motor vehicle lock after lifting the pawl;

FIG. 4 shows the motor vehicle lock after pushing open the closure element;

FIG. 5 shows the motor vehicle lock after pulling closed the lock latch; and,

FIG. 6 shows a variant of the motor vehicle lock in which both flexible pulling means act on the push-open element.

### DETAILED DESCRIPTION OF THE INVENTION

The proposed motor vehicle lock arrangement 1 is assigned to a closure element 3 that is movably coupled to a motor vehicle body 2. The closure element 3 is here, and preferably, a side door of a motor vehicle 4. However, the proposed motor vehicle lock arrangement 1 can also be applied to all other conceivable closure elements 3 of a motor vehicle 4. These include rear doors, tailgates, trunk lids, or hoods. Here, and preferably, the closure element 3 designed as a side door can be pivoted about a substantially vertical pivot axis. However, in principle, the closure element 3 can also be designed in the manner of a sliding door.

The embodiment shown in the drawings which is preferred in this respect relates to a motor vehicle lock arrangement 1 for a closure element 3 of a motor vehicle 4.

Motor vehicle lock arrangement 1 has a motor vehicle lock 5, which, in the mounted state, is arranged on the closure element 3. Alternatively, it may also be provided that the motor vehicle lock 5 is arranged on the motor vehicle body 2. The motor vehicle lock 5 is equipped with a locking mechanism 6 with a lock latch 7 and a pawl 8.

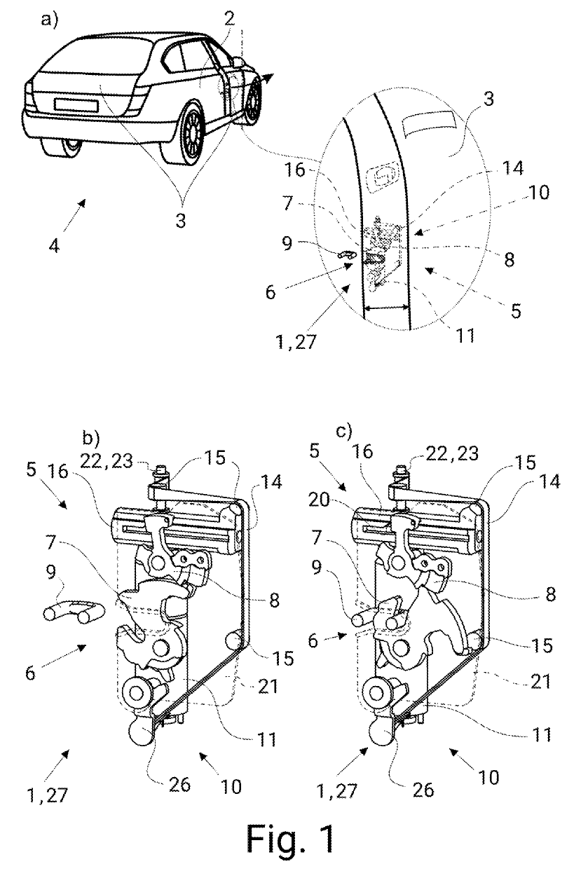

The lock latch 7 can be moved from an open position (shown in FIG. 1 b)) into at least one closing position (FIG. 1 c)), here into a main closing position and into a pre-closing position, by a movement in the closing direction (clockwise in FIG. 1). In the closing positions, the lock latch 7 engages with a locking part 9 or the like for transmitting door holding forces. The door holding forces act on the closure element 3 in its closing direction in order to counteract opening of the closure element 3.

Conversely, the lock latch 7 can be moved from the closing positions into the open position (FIG. 1 b)) by a movement in the opening direction (counterclockwise in FIG. 1), in which open position the lock latch 7 releases the locking part 9 in the opening direction of the closure element 3.

It can be seen in the drawings that the pawl 8 is assigned to the lock latch 7, and that the pawl 8 can be brought into a locking position, in which it locks the lock latch 7 in a closing position (in the main closing position in FIG. 1 c)), against pivoting in the opening direction of the lock latch 7. Furthermore, the pawl 8 can be lifted here, and preferably, by a motor into a release position, in which it releases the lock latch 7 in its opening direction so that the lock latch 7 can pivot into its open position. The lifting of the pawl 8 into the release position is associated in FIG. 1) with counterclockwise pivoting of the pawl 8. The release position of the pawl 8 is shown in FIG. 1 b).

While the pawl 8 is spring-preloaded onto the lock latch 7, the lock latch 7, also spring-preloaded, is pushed into its open position. The spring arrangements required for this purpose are not shown here for the sake of clarity. The pawl 8 and/or the lock latch 7 may have a plastics coating.

Furthermore, the motor vehicle lock arrangement 1, preferably the motor vehicle lock 5, has a drive arrangement 10 with a motor 11. A transmission 12, which can have at least one gearwheel and which is preferably a planetary transmission, can be arranged downstream of the motor 11.

The drive arrangement 10 has a first flexible pulling means 13. The motor 11 can act on the first flexible pulling means 13 in order to trigger a first function of the motor vehicle lock arrangement 1. The first function here is, by way of example, “pushing the closure element open.” The motor vehicle lock arrangement 1 is configured to trigger the first function with a first maximum pulling force of the first flexible pulling means 13. The maximum pulling force is used here, and preferably, not every time the first function is triggered, but only in some cases, for example after a crash.

It is now essential that the drive arrangement 10 has a second flexible pulling means 14. The motor 11 can act on the second flexible pulling means 14 to trigger a second function of the motor vehicle lock arrangement 1. The second function here is, by way of example, “pulling the lock latch closed.” The motor vehicle lock arrangement 1 is configured to trigger the second function with a second maximum pulling force of the second flexible pulling means 14. It is worth mentioning that the second maximum pulling force is smaller than the first maximum pulling force. During normal operation, the pulling-closed movement is therefore never triggered by a pulling force that requires the maximum force of the motor 11. The motor 11 is preferably regulated down to keep the second maximum pulling force below the first maximum pulling force.

In order to adapt the flexible pulling means 11, 12 to the installation space requirements and to provide a flexible motor vehicle lock arrangement 1, it is provided that the second flexible pulling means 14 is deflected at least once, and that the second flexible pulling means 14 is deflected more frequently and/or by a larger angular range than the first flexible pulling means 13.

As an alternative or in addition to the deflection, it is provided that, for a given equal pulling force, friction losses of the second flexible pulling means 14 are higher than friction losses of the first flexible pulling means 13. This results preferably from more frequent deflection.

The first and second flexible pulling means 14 are here, and preferably, arranged downstream of the transmission 12.

In general, it is preferably the case that the first flexible pulling means 13 and/or the second flexible pulling means 14 has/have a longitudinal direction in which the movements transmitted by each flexible pulling means 11, 12 are transmitted, and that each flexible pulling means 11, 12 is flexible, preferably pliable, transversely to the longitudinal direction, and/or that each flexible pulling means 11, 12 is stable in length in the longitudinal direction during the transmission of a movement. An advantage of a flexible pulling means 11, 12 is that a pulley block can also be implemented. Accordingly, the first flexible pulling means 13 and/or the second flexible pulling means 14 is/are preferably part of a pulley block.

In general, the term “flexible” in connection with the pulling means is understood to mean that they are flexible orthogonally to the pulling direction. In the pulling direction, the corresponding flexible pulling means 11, 12 is preferably stable in such a way that the occurring pulling forces do not cause any relevant change in the length of the flexible pulling means 11, 12.

Here, and preferably, it is provided that the first flexible pulling means 13 is deflected at least once and/or at least by 90°, and/or that the first flexible pulling means 13 is deflected at most twice, preferably at most once, and/or at most by 270°, preferably at most by 180°, more preferably at most by 120°.

The second flexible pulling means 14 is deflected here, and preferably, at least twice, preferably at least three times, and/or at least by 120°, preferably at least by 180°, more preferably at least by 200°. It can be seen in the drawings that the first flexible pulling means 13 in the illustrated embodiment is deflected exactly once and by relatively exactly 90°. The second flexible pulling means 14 is deflected three times, the first time by 90°, then again by 90°, and then by just under 45°. In total, the second flexible pulling means 14 is deflected by roughly 225°. The different orientation of the deflections is therefore ignored when adding these together.

Furthermore, it is provided here, and preferably, that the second flexible pulling means 14 is deflected by at least two, preferably at least three, deflection elements 15 separated from one another by a portion of the second flexible pulling means 14 with no deflections. The deflection elements 15 may be rollers, pins, or the like. Here, and preferably, the deflection elements 15 are formed separately from one another. The portions without deflection between the deflection elements 15 are shown here without guidance, but the second flexible pulling means 14 can also be guided in these portions. The first flexible pulling means 13 is deflected here, and preferably, by at most one deflection element 15.

It is preferably the case that the first maximum pulling force is at least 500 N, preferably at least 700 N, more preferably at least 900 N, even more preferably at least 1000 N, and/or that the second maximum pulling force is at most 700N, preferably at most 500 N, more preferably at most 400 N. Relatively speaking, the first maximum pulling force can be at least 10%, preferably at least 20%, more preferably at least 50% greater than the second maximum pulling force.

As already mentioned, the first function can be a function “pushing the closure element open.” The second function can be a function “pulling the lock latch closed” or a function “lifting the pawl.” The combination of the pushing-open and pulling-closed movement is shown in the drawings.

In an alternative embodiment, it is provided that the first function is a function “pulling the lock latch closed” and/or that the second function is a function “lifting the pawl.”

It also follows that here, and preferably, the second flexible pulling means 14 is twisted more frequently and/or by a larger angular range than the first flexible pulling means 13. Here, only the second flexible pulling means 14 is twisted once.

Furthermore, it is provided here, and preferably, that the friction losses of the second flexible pulling means 14 are at least 2%, preferably at least 5%, preferably at least 10%, even more preferably at least 20%, greater than the friction losses of the first flexible pulling means 13. The friction losses can be determined by applying force to the ends of the flexible pulling means 11, 12 that are close to the drive and determining which portion of the force arrives at the corresponding end that is remote from the drive. For comparison, the same force is applied to both flexible pulling means 11, 12.

As can also be seen in the drawings, it is here, and preferably, the case that the motor 11 can generate motor movements in a first motor direction and a second motor direction, that the motor movements in the first motor direction generate pulling movements of the first flexible pulling means 13, whereby the first function is triggered, and that the motor movements in the second motor direction generate pulling movements of the second flexible pulling means 14, whereby the second function is triggered.

In the following, the push-open function is considered first. It is here, and preferably, the case that the motor vehicle lock arrangement 1 has a push-open arrangement for pushing the closure element 3 into a gap position. The push-open arrangement has a push-open element 16, which is here, and preferably, linearly movable and/or designed as a slide, for pushing the closure element 3 into the gap position. The function “pushing the closure element open” is then a movement of the closure element 3 into the gap position.

The push-open element 16 is supported here, and preferably, on the motor vehicle body 2 when it pushes the closure element 3 into the gap position. The function of the push-open element 16 can be seen in FIG. 1a) in conjunction with FIG. 1b) and c). The motor vehicle lock 5 is shown in FIG. 1 a) to c) in the same orientation. If the push-open element 16 is moved linearly to the left, it pushes against the body and thus opens the side door. A user can reach an engagement gap created in the gap position and can manually open the closure element 3 further.

Usually, a gap of less than 10 mm, preferably of approximately 6 mm, remains between the closure element 3 and the motor vehicle body 2 in the opening direction of the closure element 3 when the lock latch 7 is in the pre-closing position. This gap is thus just of such a size that a user's hand cannot reach behind the gap, which would be associated with a considerable risk of pinching.

It is preferably the case that the pre-closing position of the closure element 3 is located between the main closing position and the gap position of the closure element 3. This means that the engagement gap resulting from the gap position of the closure element 3 is larger than the aforementioned gap between the closure element 3 and the motor vehicle body 2, which gap corresponds to the pre-closing position. Preferably, the gap width of the engagement gap is greater than 18 mm and more preferably greater than 22 mm. In a particularly preferred embodiment, the gap width of the engagement gap is between approximately 26 mm and approximately 31 mm. These values have proven to be advantageous in particular for the user's hand reaching behind the engagement gap.

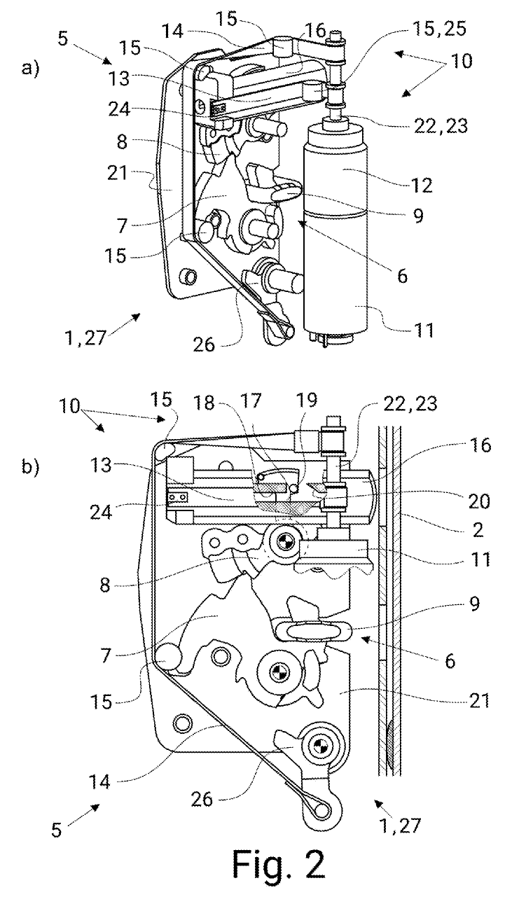

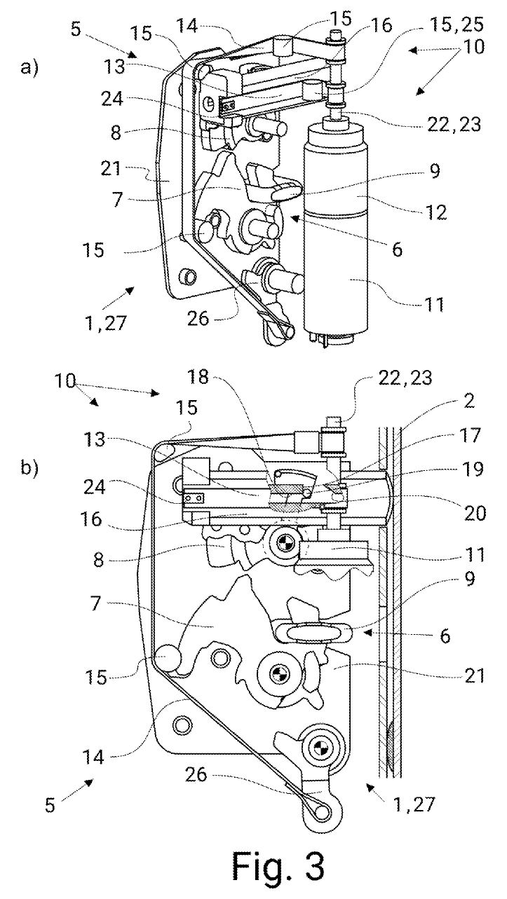

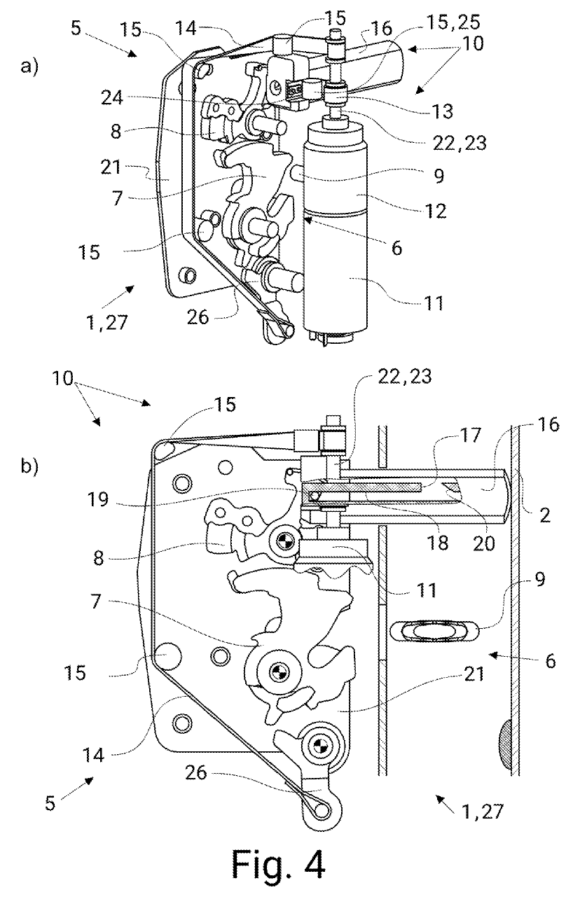

For performing the function “pushing the closure element open,” the motor 11 here, and preferably, generates motor movements in the first motor direction, which generate pulling movements of the first flexible pulling means 13, whereby the first flexible pulling means 13 moves the push-open element 16 in a push-open direction of the push-open element 16 and thus pushes the closure element 3 into the gap position. The pushing-open movement of the closure element 3 is shown starting in FIG. 2, with an intermediate position in FIG. 3 and ending in FIG. 4. During the push-open process, the first flexible pulling means 13 is here, and preferably, pulled, whereby the first flexible pulling means 13 pulls on the push-open element 16 and moves it in the direction of the motor vehicle body 2. A maximum push-open force of the push-open element 16 is here, and preferably, at least 800 N, preferably at least 1000 N.

Here, and preferably, the push-open direction of the push-open element 16 is a linear direction. Additionally, or alternatively, it is here, and preferably, the case that the push-open element 16 is formed separately from the lock latch 7. A stroke of the push-open element 16 and thus of the first flexible pulling means 13 can be at least 30 mm, preferably at least 40 mm, preferably at least or approximately 50 mm. Preferably, the stroke is at most 150 mm, preferably at most 100 mm.

Particularly with regard to FIG. 2 and FIG. 3, it is provided here, and preferably, that for performing the function “lifting the pawl,” the motor 11 generates motor movements in the first motor direction, which generate pulling movements of the first flexible pulling means 13, whereby the first flexible pulling means 13 moves the pawl 8 in an opening direction and thus lifts the pawl 8. Accordingly, it is preferably the case that the lifting and the pushing-open movements take place in a mechanically synchronized manner. This can be seen in FIG. 3. It is preferably the case that the push-open element 16 transmits a movement to the pawl 8 for lifting the pawl 8 during the function “pushing the closure element open,” wherein the push-open element 16 preferably has a driving contour 17, by means of which the push-open element 16 lifts the pawl 8.

Accordingly, it is preferably the case that the driving contour 17 acts directly on the pawl 8 or directly on an element rigidly connected to the pawl 8. It is particularly preferably the case that the pawl 8 has a metal core and a plastics component rigidly connected to the metal core, and that the driving contour 17 acts directly on the plastics component.

It can also be seen in particular in FIG. 2 to 4 that here, and preferably, during the pushing-open movement, the push-open element 16 passes through a first movement portion (from FIG. 2 to FIG. 3) and a subsequent second movement portion (from FIG. 3 to FIG. 4). In the first movement portion, the push-open element 16 lifts the pawl 8 without pushing open the closure element 3 and, in the second movement portion, the push-open element 16 pushes open the closure element 3.

In FIG. 4, for example, it can be seen that here, and preferably, the push-open element 16 holds the pawl 8 in a release position after the pawl 8 has been lifted. This allows the lock latch 7 and the locking part 9 to be moved freely. Preferably, the push-open element 16 only releases the pawl 8 from the release position when the push-open element 16 is returned in a reversing process, in particular by the motor 11. Depending on its design, such a function is known as a snow load function.

First during the push-open process, the driving contour 17 acts here, and preferably, on the pawl 8 (FIG. 2 to FIG. 3) and, during the push-open process, a support contour 18 functionally separate from the driving contour 17 subsequently acts on the pawl 8 (FIG. 4).

Preferably, the driving contour 17 points at least partially in the push-open direction of the push-open element 16 and is in particular arranged transversely to the push-open direction of the push-open element 16. Here, the driving contour 17 is arranged orthogonally in the push-open direction. During the pivoting movement of the pawl 8, an extension 19 of the pawl 8 moves along the driving contour 17 until it finally leaves the driving contour 17 and is no longer moved in the push-open direction but is only supported orthogonally to the push-open direction, here in an upward direction. Preferably, the support contour 18 therefore runs in the push-open direction of the push-open element 16. During the reversing process, the pawl 8 runs along the support contour 18 and then engages in the driving contour 17, whereby the pawl 8 is released for engagement during the further return movement of the push-open element 16.

Here, and preferably, a contour change takes place, in which the pawl 8 changes back and forth between two contours of the push-open element 16.

Furthermore, it is provided here, and preferably, that the push-open element 16 is in a zero position before the start of a push-open process, and that the pawl 8 can be lifted freely, in particular by means of mechanical redundancy, relative to the push-open element 16 when the push-open element 16 is in the zero position. Opposite the driving contour 17, the push-open element 16 has a bevel 20, which leaves sufficient space for the pawl 8 to be lifted. Of course, this does not require a bevel 20; any other free movement, in particular simply enough space, is sufficient.

In addition, it is here, and preferably, that the push-open element 16 can be returned to the zero position, without the pawl 8 engaging, after a push-open process. If the pawl 8 cannot yet engage during the reversing process because it is resting against the lock latch 7 and said lock latch is still in an open position, the extension 19 of the pawl 8 remains below the driving contour 17 and the push-open element 16 can be moved freely.

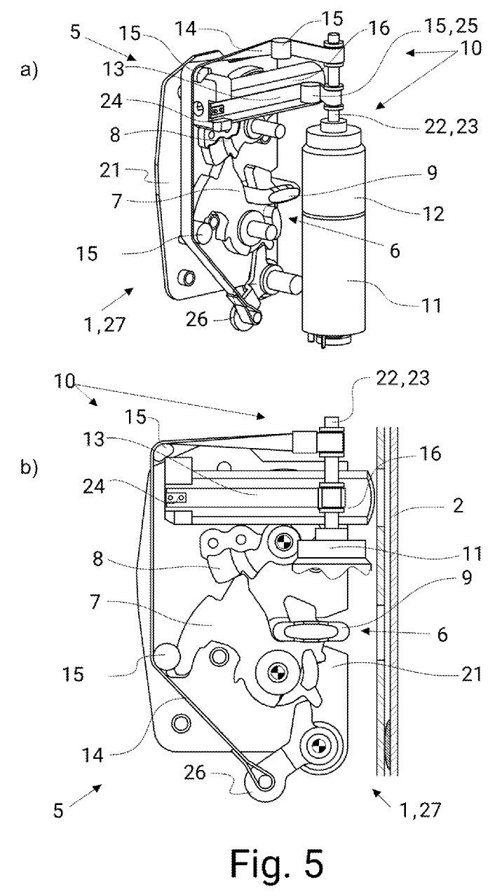

With regard to the transition from FIG. 2 to FIG. 5, it is provided here, and preferably, that, for performing the function “pulling the lock latch closed,” the motor 11 generates motor movements in the second motor direction, which generate pulling movements of the second flexible pulling means 14, whereby the second flexible pulling means 14 moves the lock latch 7 in a closing direction and thus pulls the lock latch 7 closed, in particular from the pre-closing position and/or into the main closing position. During the pulling-closed movement, a stroke of the second flexible pulling means 14 can be 20 to 40 mm, here, and preferably, about 25 mm.

As at least the perspective representations suggest, the motor 11 and/or the push-open element 16 can form a structural unit with the motor vehicle lock 5 that as such can be handled individually. This structural unit can then be mounted as such. Preferably, the motor vehicle lock 5 and the motor 11 and/or the motor vehicle lock 5 and the push-open element 16 are carried by a common carrier, particularly a carrier plate. The common carrier may, for example, be a carrier of a door module.

In a preferred embodiment, the motor vehicle lock 5 has a housing 21, on or in which the motor 11 and/or the push-open element 16 is/are arranged. The housing 21 can of course also be provided separately. Here, and preferably, the first flexible pulling means 13 and/or the second flexible pulling means 14 is/are arranged completely or with at least more than 50% of its length in the housing 21. Such an arrangement is particularly compact and makes use of the flexibility with which the motor 11 can be positioned. In addition, it may be provided that the push-open element 16 is moved out of the housing 21 of the motor vehicle lock 5 during the pushing-open movement.

It can be seen in the drawings that here, and preferably, the first flexible pulling means 13 and the second flexible pulling means 14 are coupled to the motor 11 in such a way that, when motor movements are generated in the first motor direction, the first flexible pulling means 13 is wound up and the second flexible pulling means 14 is unwound. When generating motor movements in the second motor direction, the situation is accordingly reversed.

It is preferable that the first flexible pulling means 13 and/or the second flexible pulling means 14 is/are wound onto and unwound from a winding shaft 22, the same winding shaft 22, during their movements. Preferably, the first flexible pulling means 13 and/or the second flexible pulling means 14 are wound in multiple layers onto the winding shaft 22. Additionally or alternatively, the winding shaft 22 is coaxial with a motor shaft 23 of the motor 11; in particular, the winding shaft 22 is the motor shaft 23 itself or an extension of the motor shaft 23 or an attachment to the motor shaft 23. It is conceivable that the winding radius of the flexible pulling means 11, 12 is the same or different. Different winding shafts 22 are also conceivable.

Windings of the flexible pulling means 11, 12 are not to be counted when counting the deflections and the deflection angle. The twisting mentioned above is not a deflection either.

Furthermore, it is provided here, and preferably, that the first flexible pulling means 13 is fastened directly to the push-open element 16 at a fastening point 24. Preferably, the first flexible pulling means 13 runs from the fastening point 24 along the push-open element 16 in the push-open direction of the push-open element 16 and is subsequently preferably deflected once. For this purpose, here, and preferably, a deflection pulley 25 is provided.

Here, and preferably, the motor 11 is designed to be self-locking. Preferably, the motor 11 has a gear 12, which is designed to be self-locking. Thus, the motor 11 can be switched to inactive, particularly currentless, at the end of the pushing-open process and the push-open element 16 can remain in an end position of the pushing-open process due to the self-locking function of the motor 11 so that the closure element 3 remains in the gap position.

The drawings show that the second flexible pulling means 14 is here, and preferably, fastened to a closing lever 26 for the lock latch 7. Alternatively, the second flexible pulling means 14 can be fastened to lock latch 7. Preferably, the second flexible pulling means 14 is deflected at least once, preferably multiple times. The second flexible pulling means 14 and/or the first flexible pulling means 13 can be deflected by an element, particularly a pin, fixed to the housing. This is particularly easy to implement. Here, and preferably, the second flexible pulling means 14 is twisted between two deflections. This demonstrates the high degree of flexibility when guiding the flexible pulling means 11, 12 through the motor vehicle lock 5. Additionally, or alternatively, torsion may also be provided for the first flexible pulling means 13.

It is here, and preferably, the case that the drive arrangement 10 has a zero position, in particular a zero position of the motor shaft 23. The zero position here corresponds to FIG. 2. After performing the function “lifting the pawl” and/or “pulling the lock latch closed” and/or “pushing the closure element open,” the drive arrangement 10 is returned to the zero position. The drive arrangement 10 also starts the function “lifting the pawl” and/or “pulling the lock latch closed” and/or “pushing the closure element open” from the zero position. Preferably, and as can also be seen in FIG. 2, the first flexible pulling means 13 and/or the second flexible pulling means 14 is/are pre-wound on the winding shaft 22 in the zero position.

It may be provided that the motor vehicle lock arrangement 1 has a switch for detecting the zero position of the push-open element 16 and/or a switch for detecting a push-open position of the push-open element 16, and that, based on signals from the switch(es), the motor 11 is controlled during one of the functions, in particular to terminate it.

As can also be seen in FIG. 2, when one of the flexible pulling means 11, 12 is being wound up, the other is being unwound. Accordingly, this other flexible pulling means 11, 12 is sufficiently pre-wound in the zero position to be able to be sufficiently unwound. A guide for unwinding one or both flexible pulling means 11, 12 may be provided, which guide in particular prevents each flexible pulling means 11, 12 from assuming uncontrolled positions during unwinding. The guide can, for example, be provided laterally of the flexible pulling means 11, 12 so that unwinding is guided, preferably in a reproducible manner. Additionally, or alternatively, a strap tensioner may be provided for one or both flexible pulling means 11, 12. The strap tensioner tensions the flexible pulling means 11, 12 during unwinding and may be provided, for example, by the leg of a spring, which is preferably also used for other purposes. In this way, each flexible pulling means 11, 12 is also reproducibly guided.

In order not to have to pre-wind the flexible pulling means 11, 12 as much, it can be provided that the first flexible pulling means 13 and/or the second flexible pulling means 14 is/are turned over on the winding shaft 22 during at least one of the functions “lifting the pawl,” “pulling the lock latch closed” and “pushing the closure element open.” This variant can be explained using the example strokes of 50 mm during the pushing-open movement and 25 mm during the pulling-closed movement. During pushing-open, the first flexible pulling means 13 is wound up and the second is accordingly unwound. For this purpose, the second flexible pulling means 14 must also allow a stroke of 50 mm during unwinding. It would be conceivable to pre-wind the second flexible pulling means 14 by 50 mm. However, it is also possible to pre-wind the second flexible pulling means 14 only approximately 25 mm, plus a tolerance if necessary. The second flexible pulling means 14 then unwinds, for example 25 mm, turns over, and winds up 25 mm again, while the first flexible pulling means 13 performs a 50-mm stroke. During this time, the second flexible pulling means 14 does not act on the closing lever 26. This turn-over results in less of the flexible pulling means 11, 12 being unwound, less flexible pulling means 11, 12 being required, and the winding radius of the flexible pulling means 11, 12 becoming smaller, which increases efficiency.

It is therefore provided here, and preferably, that the first flexible pulling means 13 and/or the second flexible pulling means 14 is/are pre-wound between 50% and 90%, preferably between 60% and 80%, of the maximum stroke of the other flexible pulling means 11, 12.

Preferably, the first flexible pulling means 13 is turned over on the winding shaft 22 during the function “pulling the lock latch closed” and/or the second flexible pulling means 14 is turned over on said winding shaft during the function “lifting the pawl” and/or “pushing the closure element open.”

It is possible that the push-open element 16 is returned in a spring-driven manner after the pushing-open movement and/or the closing lever 26 is returned in a spring-driven manner after the pulling-closed movement and/or the pawl 8 is returned in a spring-driven manner after the lifting movement, preferably while the drive arrangement 10 is returned to the zero position. Due to its self-locking nature, the motor 11 preferably rotates in the opposite direction to the motor direction assigned to each function.

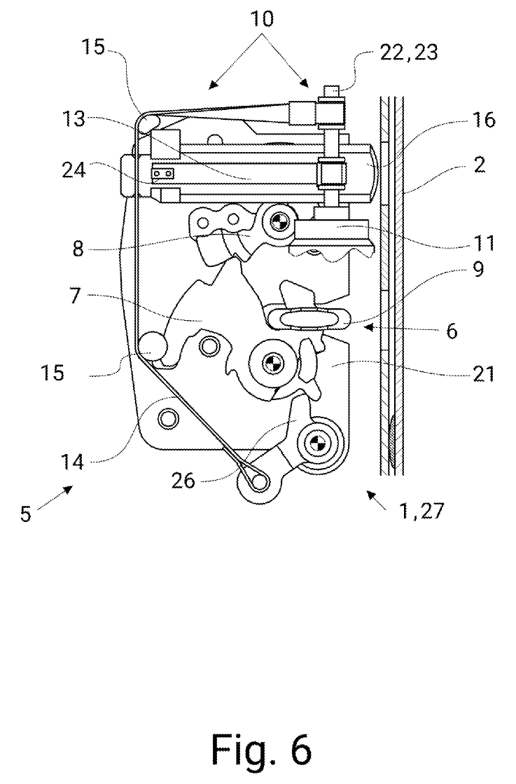

Alternatively, or additionally, it may be provided that the second flexible pulling means 14 also interacts with the push-open element 16. FIG. 6 shows this variant. In this case, it is preferably the case that the second flexible pulling means 14 returns the push-open element 16, when the motor 11 generates motor movements in the second motor direction. Additionally, or alternatively, and implemented in FIG. 6, the push-open element 16 tensions the second flexible pulling means 14 while said pulling means is unwound during the function “pushing the closure element open.” With suitable coordination, it is thus possible, on the one hand, to prevent the second flexible pulling means 14 from having too much free space during the stroke of the push-open element 16 and, on the other hand, to dispense with a return spring for the push-open element 16. In this case, the second flexible pulling means 14 preferably does not turn over. However, for the first one, turning over may still be provided.

In general, it is here, and preferably, the case that the first flexible pulling means 13 and/or the second flexible pulling means 14 is/are a strap and/or sheathless. A sheath such as that in a Bowden cable reduces the flexibility of the flexible pulling means 11, 12 but increases its resistance to external influences. A strap can also be flexibly placed around multiple corners and has a high level of stability.

Preferably, the first flexible pulling means 13 and/or the second flexible pulling means 14 has/have a width that is at least 1.5 times, preferably at least 4 times, more preferably at least 8 times, the thickness of the corresponding flexible pulling means 11, 12. Here, and preferably, the thickness of the first flexible pulling means 13 and/or of the second flexible pulling means 14 is between 0.5 mm and 1.5 mm, here 1 mm, and/or the width is between 6 mm and 14 mm, preferably between 8mm and 12 mm, here 10 mm. The width and thickness are orthogonal to the longitudinal direction. Additionally, or alternatively, it may be provided that the first flexible pulling means 13 and/or the second flexible pulling means 14 has/have an oval or rectangular cross section. The cross section is also to be considered orthogonally in the longitudinal direction. The first flexible pulling means 13 and/or the second flexible pulling means 14 can be made of a textile material.

Furthermore, it is provided here, and preferably, that the motor vehicle lock arrangement 1, in particular the motor vehicle lock 5, has a control unit, that the control unit controls the motor 11 depending on the function and/or depending on the application of the function in order to provide a different output power, for example by means of PWM (pulse width modulation). The control unit can be arranged in the housing 21. During pushing-open, a force of 100 to 300 N, for example 150 N, is normally preferably provided. In the event of freezing of the closure element 3, a force of 400 to 700 N, for example 500 N, is preferably provided. After a crash, which can be communicated, for example, by a crash signal, a force of at least 800 N, for example at least 1000 N, is preferably provided. During the pulling-closed movement, a force of 400 N is preferably provided. The force always relates to the flexible pulling means 11, 12 behind the winding shaft 22 and before losses.

The drive arrangement 10 may have a PWM driver stage in order to control the motor 11 with PWM. Electrical connections in the form of a lead frame can be provided, which can be embedded in the housing 21. The control unit may have a microprocessor. The operating voltage of the motor 11 can be less than or equal to 48 V. The motor 11 may be a DC motor and/or have brushes or be brushless. The motor 11 may have copper windings.

According to a further teaching, a functional arrangement 27 for a motor vehicle 4 is proposed, wherein the functional arrangement 27 has a drive arrangement 10 with a motor 11, wherein the drive arrangement 10 has a first flexible pulling means 13, wherein the motor 11 can act on the first flexible pulling means 13 in order to trigger a first function of the motor vehicle 4, in particular of the functional arrangement 27, wherein the functional arrangement 27 is configured to trigger the first function with a first maximum pulling force of the first flexible pulling means 13. According to this teaching, it is essential that the drive arrangement 10 has a second flexible pulling means 14, that the motor 11 can act on the second flexible pulling means 14 in order to trigger a second function of the motor vehicle 4, in particular of the functional arrangement 27, that the functional arrangement 27 is configured to trigger the second function with a second maximum pulling force of the second flexible pulling means 14, that the second flexible pulling means 14 is deflected at least once, and that the second flexible pulling means 14 is deflected more frequently and/or by a larger angular range than the first flexible pulling means 13. Preferably, the second maximum pulling force is smaller than the first maximum pulling force.

Reference may be made to all the statements relating to the proposed motor vehicle lock arrangement 1.

According to a further teaching, a motor vehicle 4 is proposed that comprises a motor vehicle lock arrangement 1 as proposed or a functional arrangement 27 as proposed.

Reference may be made to all the statements relating to the proposed motor vehicle lock arrangement 1 and the proposed functional arrangement 27.

What is claimed is:

1. A motor vehicle lock arrangement for a closure element of a motor vehicle, the motor vehicle lock arrangement comprising
a motor vehicle lock having a locking mechanism with a lock latch and a pawl, the motor vehicle lock arrangement having a drive arrangement with a motor,
the drive arrangement having a first flexible pulling means, it being possible for the motor to act on the first flexible pulling means in order to trigger a first function of the motor vehicle lock arrangement,
the motor vehicle lock arrangement being configured to trigger the first function with a first maximum pulling force of the first flexible pulling means, wherein the drive arrangement has a second flexible pulling means, that the motor can act on the second flexible pulling means in order to trigger a second function of the motor vehicle lock arrangement, that the motor vehicle lock arrangement is configured to trigger the second function with a second maximum pulling force of the second flexible pulling means, that the second maximum pulling force is smaller than the first maximum pulling force, that the second flexible pulling means is deflected at least once, and that the second flexible pulling means is deflected more frequently and/or by a larger angular range than the first flexible pulling means, and/or in that, for a given equal pulling force, friction losses of the second flexible pulling means are higher than friction losses of the first flexible pulling means.

2. The motor vehicle lock arrangement according to claim 1, wherein the first flexible pulling means is deflected at least once and/or at least by 90°, and/or in that the first flexible pulling means is deflected at most twice, preferably at most once, and/or at most by 270°, preferably at most by 180°, more preferably at most by 120°, and/or in that the second flexible pulling means is deflected at least twice, preferably at least three times, and/or at least by 120°, preferably at least by 180°, more preferably at least by 200°.

3. The motor vehicle lock arrangement according to claim 1, wherein the second flexible pulling means is deflected by at least two, preferably at least three, deflection elements separated from one another by a portion of the second flexible pulling means comprising no deflections, and/or in that the first flexible pulling means is deflected by at most one deflection element.

4. The motor vehicle lock arrangement according to claim 1, wherein the first maximum pulling force is at least 500 N, preferably at least 700 N, more preferably at least 900 N, even more preferably at least 1000 N, and/or in that the second maximum pulling force is at most 700 N, preferably at most 500 N, more preferably at most 400 N, and/or in that the first maximum pulling force is at least 10%, preferably at least 20%, more preferably at least 50%, greater than the second maximum pulling force.

5. The motor vehicle lock arrangement according to claim 1, wherein the first function is the function “pushing the closure element open,” and/or in that the second function is the function “pulling the lock latch closed” or the function “lifting the pawl.”

6. The motor vehicle lock arrangement according to claim 1, wherein the first function is the function “pulling the lock latch closed,” and/or in that the second function is the function “lifting the pawl.”

7. The motor vehicle lock arrangement according to claim 1, wherein the second flexible pulling means is twisted more frequently and/or by a larger angular range than the first flexible pulling means.

8. The motor vehicle lock arrangement according claim 1, wherein the friction losses of the second flexible pulling means are at least 2%, preferably at least 5%, more preferably at least 10%, even more preferably at least 20%, greater than the friction losses of the first flexible pulling means.

9. The motor vehicle lock arrangement according to claim 1, wherein the motor can generate motor movements in a first motor direction and a second motor direction, in that the motor movements in the first motor direction generate pulling movements of the first flexible pulling means, as a result of which the first function is triggered, and in that the motor movements in the second motor direction generate pulling movements of the second flexible pulling means, as a result of which the second function is triggered.

10. The motor vehicle lock arrangement according to claim 5, wherein the motor vehicle lock arrangement has a push-open arrangement for pushing the closure element into a gap position, in that the push-open arrangement has a push-open element for pushing the closure element into the gap position, in that the function “pushing the closure element open” is the movement of the closure element into the gap position, and in that, for performing the function “pushing the closure element open,” the motor generates motor movements in the first motor direction, which generate pulling movements of the first flexible pulling means, as a result of which the first flexible pulling means moves the push-open element in a push-open direction of the push-open element and thus pushes the closure element into the gap position.

11. The motor vehicle lock arrangement according to claim 5, wherein for performing the function “lifting the pawl,” the motor generates motor movements in the first motor direction, which generate pulling movements of the first flexible pulling means, as a result of which the first flexible pulling means moves the pawl in an opening direction and thus lifts the pawl, preferably in that, during the function “pushing the closure element open", the push-open element transmits a movement to a pawl for lifting the pawl, preferably in that the push-open element has a driving contour, by means of which the push-open element lifts the pawl.

12. The motor vehicle lock arrangement according to claim 5, wherein for performing the function “pulling the lock latch closed,” the motor generates motor movements in the second motor direction, which generate pulling movements of the second flexible pulling means, as a result of which the second flexible pulling means moves the lock latch in a closing direction and thus pulls closed the lock latch, in particular from a pre-closing position and/or into a main closing position.

13. The motor vehicle lock arrangement according to claim 1, wherein the first flexible pulling means and/or the second flexible pulling means is/are wound onto a winding shaft and unwound from the winding shaft during their movements, preferably in that the first flexible pulling means and/or the second flexible pulling means is/are wound onto the winding shaft in multiple layers, and/or in that the winding shaft is coaxial with a motor shaft of the motor, in particular the motor shaft itself or an extension of the motor shaft or an attachment to the motor shaft.

14. The motor vehicle lock arrangement according to claim 1, wherein the first flexible pulling means and/or the second flexible pulling means is/are a strap and/or is sheathless, preferably in that the first flexible pulling means and/or the second flexible pulling means has/have a width that is at least 1.5 times, preferably at least 4 times, more preferably at least 8 times, as large as the thickness of the corresponding flexible pulling means, and/or in that the first flexible pulling means and/or the second flexible pulling means has/have an oval or rectangular cross section.

15. The motor vehicle lock arrangement according to claim 1, wherein the motor vehicle lock arrangement, in particular the motor vehicle lock, has a control unit, in that the control unit controls the motor depending on the function and/or depending on the application of the function in order to provide a different output power.

16. A functional arrangement for a motor vehicle, the functional arrangement having a drive arrangement with a motor, the drive arrangement having a first flexible pulling means, it being possible for the motor to act on the first flexible pulling means in order to trigger a first function of the motor vehicle, in particular of the functional arrangement, the functional arrangement being configured to trigger the first function with a first maximum pulling force of the first flexible pulling means, wherein that the drive arrangement has a second flexible pulling means, in that the motor can act on the second flexible pulling means in order to trigger a second function of the motor vehicle, in particular of the functional arrangement, in that the functional arrangement is configured to trigger the second function with a second maximum pulling force of the second flexible pulling means, in that the second flexible pulling means is deflected at least once, and in that the second flexible pulling means is deflected more frequently and/or by a larger angular range than the first flexible pulling means, preferably in that the second maximum pulling force is smaller than the first maximum pulling force.

17. A motor vehicle comprising a motor vehicle lock arrangement according to claim 1.

18. The motor vehicle lock arrangement according to claim 2, wherein the second flexible pulling means is deflected by at least two, preferably at least three, deflection elements separated from one another by a portion of the second flexible pulling means comprising no deflections, and/or in that the first flexible pulling means is deflected by at most one deflection element.

19. The motor vehicle lock arrangement according to claim 2, wherein the first maximum pulling force is at least 500 N, preferably at least 700 N, more preferably at least 900 N, even more preferably at least 1000 N, and/or in that the second maximum pulling force is at most 700 N, preferably at most 500 N, more preferably at most 400 N, and/or in that the first maximum pulling force is at least 10%, preferably at least 20%, more preferably at least 50%, greater than the second maximum pulling force.

20. The motor vehicle lock arrangement according to claim 3, wherein the first maximum pulling force is at least 500 N, preferably at least 700 N, more preferably at least 900 N, even more preferably at least 1000 N, and/or in that the second maximum pulling force is at most 700 N, preferably at most 500 N, more preferably at most 400 N, and/or in that the first maximum pulling force is at least 10%, preferably at least 20%, more preferably at least 50%, greater than the second maximum pulling force.
